(19) United States
(12) Patent Application Publication
(10) Pub. No.: US 2005/0259931 A1
(43) Pub. Date: Nov. 24, 2005

(54) Fiber-optic device for the interior lighting of kitchen and household appliances

(75) Inventors: Ekkehard Gaydoul, Gross-Biberau (DE); Sylvia Sieben, Nieder-Olm (DE)

Correspondence Address: LERNER AND GREENBERG, PA, P O BOX 2480, HOLLYWOOD, FL, 33022-2480, US

(73) Assignee: Schott AG

(21) Appl. No.: 11/133,876

(22) Filed: May 19, 2005

(30) Foreign Application Priority Data
May 19, 2004 (DE) 10 2004 025 326.9

(51) Int. Cl. G02B 6/06

(52) U.S. Cl. 385/116

(57) ABSTRACT

A fiber-optic device for lighting the interior space of a household or kitchen appliance includes optical fibers. The light entry ends of the optical fibers are assigned to a light source which is disposed away from the useful region of the interior space of the appliance. The optical fibers are grouped into flexible fiber bundles which extend with small bending radii from the light source to the inner walls of the appliance. Light exit ends of the fiber bundles form point light sources distributed on the inner walls of the appliance for an even illumination of the appliance interior space. The light source is advantageously disposed away from heated or refrigerated regions of the appliance. The fiber-optic device is advantageously mass-produced as a module which can be easily installed and serviced.

### BACKGROUND OF THE INVENTION

Field of the Invention

The invention relates to a fiber-optic device for the interior lighting of kitchen and household appliances, preferably for baking and refrigerating appliances for industrial use. An interior space of the appliance is surrounded by inner walls and has at least one useful level. The fiber-optic device includes light-conducting fibers having light entry ends and light exit ends. The light entry ends are assigned to at least one light source, which is disposed away from the useful region of the interior space of the appliance.

The lighting installation for illuminating interior spaces is intended for appliances which have a housing and an inner side including inner walls between which there is an installation space in which items of equipment, electronic and mechanical components are accommodated. Cooking appliances, baking appliances and refrigerating appliances are considered here in particular as the appliances. In the case of these appliances, a certain impermeability of the inner walls is absolutely necessary—in the case of cooking and baking appliances, such as microwave appliances and baking ovens, to prevent excessive heat from getting into the installation space and damaging components or cables; in the case of refrigerating appliances, to allow the refrigerating temperature in the interior space to be maintained economically in terms of energy.

Lighting systems for the interior of baking ovens are known from German Published, Non-Prosecuted Patent Application No. DE-A 3803717. In these systems, incandescent lamps are arranged such that they are thermally separated from the baking space, the light of the incandescent lamps passing into the interior space of the baking ovens through a glass surface. The glass surfaces are formed of heat-resistant glass, which keeps the heat produced in the baking space during baking away from the incandescent lamps. In the case of other embodiments of interior baking space lighting systems, the glass surfaces are formed as half shells and are mounted on one or more of the inner walls of the baking space. In these cases it is possible for the half-shell-shaped glass surface to cover one or more of the incandescent lamps provided. Alternatively, lighting recesses may be formed in the inner walls of the baking space, accommodating a number of incandescent lamps and being covered and separated from the baking space by correspondingly suitable glass surfaces.

It has proven to be a disadvantage of conventional interior baking space lighting systems that the incandescent lamps with the corresponding glass surfaces that are provided for the lighting have to be kept small in their construction in relation to the baking space area that is to be illuminated, since the devices for heating necessarily have to be distributed uniformly on the inner walls and the lighting devices in the baking space should be easily accessible and easy to clean. As a result, it is generally only possible to illuminate the baking space with high intensity in the area of the light source, the other areas tending to be poorly illuminated or darkened by baking sheets or baking space dividers. In this case, the uneven illumination proves to be particularly disadvantageous when visual inspection of the items being baked or cooked is required during baking.

On account of the high operating temperatures (up to about 300° C.) prevailing in the interior of the oven and on account of the vibrations caused by the heating and air-circulating mechanism, the service life of the lamps to be used here is particularly restricted. These lighting devices must be frequently exchanged, for which servicing openings, for example, have to be provided on the outer side walls of the baking oven. If a number of ovens are standing next to one another, wall-to-wall, access to these servicing openings is difficult or impossible, so that, after the first lamps fitted have failed, generally the baking ovens have to be operated without interior lighting, with corresponding restrictions on their operating capability.

These disadvantages can be reduced with indirect lighting through the use of a light source arranged away from the useful space. The useful space is, for example, in the case of baking ovens the interior space of the baking oven, in the case of microwave appliances the cooking space and in the case of refrigerating appliances the refrigerating space. With this positioning of the light source, the light is conducted to the useful space via glass fibers.

German Patent No. DE 41 00 605 C2 discloses a lighting system for the interior space of a baking oven, which in the case of baking ovens is provided with a number of baking levels and is implemented through the use of distributor heads. In the case of this lighting system, only the space respectively around the distributor head can be illuminated well, the distributor head replacing the conventional incandescent lamps. Here it is already a constructionally complex undertaking to provide the baking space interior lighting, since the side walls or the rear wall in the interior space of the baking oven are generally already fitted with guiding and fastening devices for baking sheets or baking space dividers and also ventilating devices for air-circulating functions of the baking oven, so that there is no space left for the distributor heads.

The thicknesses of glass fiber bundles required for providing the lighting power of the incandescent lamps are restricted in the amount they can bend and are laid loosely in the installation space to make them better able to bend. This has the disadvantage that the glass fibers are exposed to damage since they are unprotected during repair, servicing or transporting of the appliance, and as a consequence the lighting power is reduced. Furthermore, it is not possible for the fibers to be led into moving housing parts, such as the door of the appliance, because of the risk of damage.

In addition, the lamps or distributor heads that are usually attached in the middle of the side walls of the interior space for the lateral lighting of the baking levels, or the lamps or distributor heads fastened to the rear wall, can be accessed only with difficulty through the baking oven door because of the depth of the baking space, and in particular also because of the relatively small distance between the baking levels, and therefore can only be cleaned laboriously or only with special aids.

### SUMMARY OF THE INVENTION

It is accordingly an object of the invention to provide a device for lighting the interior space of an appliance which overcomes the above-mentioned disadvantages of the heretofore-known devices of this general type and which facilitates the servicing and cleaning of the appliance and with which it is possible to provide optimum lighting for the interior space of the appliance, in particular the individual useful levels, and which can be provided simply and inexpensively, preferably as a prefabricated component, for the production of the appliance.

With the foregoing and other objects in view there is provided, in accordance with the invention, in combination with an appliance having inner walls surrounding an appliance interior space defining a useful region with a useful level, a fiber-optic device for lighting the appliance interior space, including:
optical fibers having respective light entry ends and light exit ends;
a light source disposed away from the useful region of the appliance interior space, the light entry ends being assigned to the light source;
the optical fibers being grouped into fiber bundles;
the fiber bundles being flexible and extending, with given bending radii, from the light source to the inner walls of the appliance; and
the fiber bundles forming, with the light exit ends, point light sources distributed on the inner walls of the appliance for an even illumination of the appliance interior space.

In other words, according to the invention, there is provided a fiber-optic device for the interior lighting of kitchen and household appliances, preferably for baking and refrigerating appliances for industrial use, with an interior space of the appliance surrounded by inner walls, with at least one useful level, the fiber-optic device including light-conducting fibers having light entry ends and light exit ends and the light entry ends being assigned to at least one light source, which is disposed away from the useful area of the interior space of the appliance, wherein the glass fibers or light-conducting optical fibers of the fiber-optic device are grouped together into flexible fiber bundles with small bending radii, such that it is possible for the fiber bundles to be led from the light source to the inner walls and such that the light exit ends of the fiber bundles form distributed punctiform lighting locations or point light sources on the inner walls for an even illumination of the interior space.

One advantage of the device according to the invention is that, by the use of light-conducting fibers, the light source is arranged separated from the heating area of the baking oven or from the cooling area of a refrigerator. The light-conducting fibers conduct the light from the light source to the point where the baking or cooling space is to be lit by them. In this respect, it is immaterial whether this point lies in hot areas of the baking oven or in the freezer compartment of the refrigerator, since the light-conducting fibers can readily be exposed to the customary temperatures of these appliances. For lighting the interior of the appliance, it is consequently possible to use conventional light sources, which are inexpensive and have adequately high lighting power. In this respect, the configuration or placement of the light sources according to the invention is independent of customary restrictions with respect to high or low ambient temperatures.

It is in this respect provided that the fibers are led from the outside through the inner walls of the appliance or corresponding light coupling can be used for this on the inner walls, so that the light-radiated out of the light exit ends of the fibers can be shone into the interior of the appliance.

In this respect it is also provided that the light source and the light entry ends of the fibers are arranged at an easily accessible location of the appliance, preferably in the area of the front panel of the appliance. In an advantageous way, the servicing effort for exchanging and cleaning the light sources is reduced as a result, since the front area of the appliance is usually freely accessible. The configuration according to the invention of appliances arranged at working level or workplace level has proven to be particularly advantageous, since servicing can in this case be comfortably performed while standing. For this purpose, the light source may also be disposed in the area of the switch devices of the appliance.

It has also proven to be particularly expedient in the case of baking ovens for the light source and the light entry ends of the fibers to be arranged beneath the baking space. In the case of this configuration, the light source is arranged in an area of the baking oven which is generally heated up the least by the baking heat. In the case of conventional baking oven constructions, the area of the interior space of the baking oven that lies outside the baking space is additionally ventilated from below, so that as a result the operating heat of the light source disposed according to the invention can be dissipated upward by the ventilation provided at the bottom, which significantly extends the service life of conventional light sources.

In the case of refrigerating appliances, the installation space for the equipment is generally arranged in the lower area, so that in this area there is adequate space for the central light source.

Another embodiment according to the invention is provided by the fiber-optic device including a plurality of individual fibers and/or fiber bundles of individual fibers, the individual fibers of the fiber bundles preferably having a diameter of between 50 and 100 μm. It is provided that the light from the fibers is accepted centrally from one or more light sources. To make it possible for adequate light to be conducted to various locations of the baking space, it is provided furthermore to group together an adequately large number of individual fibers in a fiber bundle and lead them away correspondingly from the light source, a plurality of fiber bundles of a manageable diameter being laid in the installation space of the baking oven, and it consequently being possible for a correspondingly large number of lighting locations to be realized on the inner walls, so that optimum illumination of the interior space is ensured.

Use of the fiber thicknesses according to the invention has the advantage that the light-conducting fibers or fiber bundles can be laid in the interior of baking ovens without additional measures. Consequently, with providing of one or more central light sources, a plurality of fiber bundles can be led to each location of the installation space.

In this respect, it is provided according to the invention that the fiber bundles and/or the individual fibers have bending radii which are less than or equal to 10 mm. This ensures that the fibers can also be led through narrow areas of the installation space without any problem, so that it is possible to light every location of the baking space.

Furthermore, it is provided according to the invention that the fiber bundles and/or the individual fibers are accommodated in a protective cladding of temperature-resistant, preferably bendable, and/or chemically resistant material and/or braided fabrics of temperature-resistant material. In an advantageous way, it is ensured as a result that the fibers are accommodated in a shock-resistant manner and damage to the fibers in the installation space, in particular fiber breakages which reduce the lighting power of the device according to the invention, cannot readily occur during installation, transportation or servicing of the baking oven.

According to the invention, this is achieved by the protective cladding formed of extrudable plastic and/or braided fabrics of temperature-resistant and/or chemically resistant plastic, glass or metal. In this respect, the fibers or fiber bundles may be produced in a standardized form in a simple and inexpensive way and be grouped together with the intended light intensity or number of fibers.

A further embodiment of the device according to the invention is provided by the individual fibers being formed of glass and/or heat-resistant light-conducting plastic. In order that the fiber bundles can accept the light emitted by the light source in an optimum way, it is further provided that the individual fibers are grouped together at the light entry end into a common fiber bundle, preferably with a light accepting surface for coupling in the light emitted by the light source.

Furthermore, it is provided that the individual fibers are grouped together at the light exit ends into fiber bundles, preferably with a diameter of between 3 and 6 mm. The individual fibers grouped together in this way consequently make it possible in an advantageous way for the lighting points or point light sources produced at the light exit ends to be adequately bright. The lighting of one light entry surface can consequently be realized more easily than the light entry surfaces of a number of fiber bundles or blocks of fiber bundles.

According to the invention, it is provided in this respect that the light exit ends are assigned to the inner walls of the appliance space, preferably are integrated in the inner walls and/or can be led through the inner walls. One advantage of this embodiment is that any desired distribution of the lighting points on the inner walls of the appliance is made possible, the fiber bundles being able to be led in each case to the locations of the inner walls at which the light exit ends are to be fastened or led through.

In this respect it is advantageously provided according to the invention that the light exit ends of the fiber bundles are accommodated in the inner walls directly and/or in adjustable mounts for the setting of the lighting direction. This makes it possible to set the light exit ends of the fiber bundles individually, so that special aspects of the configuration of the interior space of the appliance or use of the interior space of the appliance can be taken into account in production, servicing or use.

Furthermore, it is provided that, to increase the temperature resistance, the light exit ends of the glass fibers are adhesively bonded to one another in a temperature-resistant manner and/or are accommodated in temperature-resistant sleeves. This has the effect in particular of avoiding fraying or burning away of the light exit ends and the areas of a baking space that are to be illuminated only being able to be illuminated inadequately after some time in operation. In addition, it is of advantage that the fiber bundles can be handled in a simple way, and in particular can be easily inserted through the inner walls of the appliance or be fastened to them by fastening devices. In this respect, there is a reduced risk of the light exit ends causing leaks to develop at the inner walls of the appliance, which is particularly important for example for baking ovens and refrigerators.

Alternatively, it is provided that the light exit ends of the individual fibers are fused by hot melting to increase the temperature resistance of the fiber bundles. The light exit ends can in this way be led into the baking space of a baking oven. It is of advantage in this respect that the fibers or fiber bundles can be used without additional optical or heat-insulating devices for the interior lighting of the baking space.

The two embodiments described above of the light exit ends treated at their ends additionally have the advantage that they soil less in the fitted state and are easier to clean than untreated light exit ends.

In a further embodiment of the device according to the invention, it is provided that the inner walls of the baking space include one or more baking space dividers with their own fiber-optic device and connecting elements for light coupling to the fiber-optic device of the baking oven. Baking space dividers generally serve the purpose of separating individual baking levels of the baking space from one another, so that the baking levels arranged one above the other can in each case be heated evenly from above and below. Baking space dividers may be arranged fixedly in the baking space or be intended for taking out. Baking space dividers usually have an upper heating surface or lower heating surface. In an advantageous way, it is provided according to the invention that the baking space dividers have a fiber-optic device which can be coupled or connected to the fiber-optic device of the baking oven, so that the light of the central light source is conducted into the fiber-optic device of the baking space divider, the light exit ends lighting the baking space through the upper or lower heating surface of the baking space divider.

In a further embodiment of the device according to the invention, it is provided that light exit ends are integrated in the inner walls and/or the door of the appliance in the front area of the appliance and that the light emitted from these light exit ends is directed into the interior space of the appliance.

Because of the low space requirement of the fiber bundles in the installation space and of the light exit ends in the interior space of the appliance, it is advantageously possible to arrange the light exit ends according to the invention in the appliance door or on the inner walls in the front area of the appliance without them getting in the way during use of the appliance. This allows the effect to be achieved that the incident light is directed into the interior space of the appliance from the front, and in the viewing direction of the user, so that it is possible for example to avoid disturbing reflective effects on the glass plates of the baking oven window, which would make visual inspections of the items being baked or cooked in the baking space through the baking oven window more difficult.

Furthermore, the interior space of the appliance remains optimally illuminated even when the appliance door is open. Furthermore, the device according to the invention additionally avoids operating personnel being dazzled by the front interior lighting of the appliance. It has additionally proven to be advantageous that the light exit ends arranged in this way can be easily cleaned because of their easy accessibility.

Furthermore, it is provided that the light emitted into the interior space of the appliance can be modulated by integrated and/or additional optical elements, preferably of temperature-resistant glass, at the light exit ends. The light emission, predetermined by the form of the light exit ends, may if necessary be modulated by additional optical elements, preferably of glass, according to the invention in such a way that each useful level is evenly illuminated by one or more points of light in the inner walls of the appliance. This allows the number of light exit ends, and consequently the number of fibers, for optimum illumination of the appliance to be reduced, and in addition the effect to be achieved, for example in the case of baking ovens, that the light exit ends are protected from direct exposure to the heat of the baking space.

On the one hand, in this way the thermal loading of the light exit ends can be reduced in the case of baking ovens. On the other hand, for the cleaning of the interior space of the appliance, it is possible also to allow conventional, in particular chemical, cleaning agents or scouring or scraping cleaning methods to be used for cleaning the baking space, as appropriate for the material from which the optical elements or inner walls are made.

In addition, with the additional optical elements it is possible to improve the aesthetic appearance of the interior space of the appliance by construction-related choice of special forms, materials or ways of providing lighting. According to the invention, it is provided in this respect that the light can be modulated at the light exit ends about the light exit axis in a conical and rotationally symmetrical manner.

Furthermore, it is provided that each useful level of the appliance can be evenly illuminated by a number of light exit ends. This makes it possible to avoid areas of the items being baked or cooked being darkened by baking sheets on neighboring baking levels or by the baking space dividers in the baking oven. In the case of refrigerators, darkening caused by the items that are refrigerated can be avoided in particular.

It has proven to be particularly advantageous that the light source includes at least one halogen reflector lamp and/or light emitting diode (LED) light source with at least one LED for each fiber bundle. It is consequently possible to use light sources which are vibration- and shock-resistant and, having a long service life in comparison with conventional lighting by incandescent lamps, additionally reduce the servicing intervals on the appliances and lower related costs.

Furthermore, the coupling-in of the light of such light sources can be realized with simple devices or measures and, given appliances of conventional sizes, generally no more than two halogen reflector lamps are required for optimum lighting of the interior space of the appliance, so that the appliance interior lighting system according to the invention can be advantageously provided inexpensively and economically with regard to energy consumption. LED light sources can be grouped together into luminous elements which light the light accepting surface of grouped-together fiber bundles or else the light entry surfaces of the individual fiber bundles. It is also possible, however, for groups of individual LEDs to be used for the lighting of the light entry surfaces of individual fiber bundles.

The main advantages can be summarized as being that the light source can be arranged independently of the lighting locations in the appliance, i.e. away from heating or refrigerating areas in the case of a baking oven or refrigerator, that the device can be mass-produced as a module which can be easily installed, that the appliances can be serviced and cleaned more easily and that an improvement of the lighting is achieved by even illumination of the interior space of the appliance.

With the objects of the invention in view there is also provided, an appliance, including:
inner walls surrounding an appliance interior space which defines a useful region with a useful level;
a fiber-optic device for lighting the appliance interior space;
the fiber-optic device including optical fibers with respective light entry ends and light exit ends, a light source disposed away from the useful region of the appliance interior space, the light entry ends being assigned to the light source;
the optical fibers being grouped into fiber bundles;
the fiber bundles being flexible and extending, with given bending radii, from the light source to the inner walls; and
the fiber bundles forming, with the light exit ends, point light sources distributed on the inner walls for an even illumination of the appliance interior space.

In accordance with another feature of the invention, the inner walls are baking appliance walls or refrigerating appliance walls for industrial use.

In accordance with yet another feature of the invention, the fiber-optic device is configured as an interior lighting for a kitchen appliance or a household appliance.

In accordance with another feature of the invention, the light exit ends are integrated in the inner walls or the light exit ends extend through the inner walls.

In accordance with a further feature of the invention, the light exit ends are accommodated directly in the inner walls for setting a lighting direction.

In accordance with another feature of the invention, the fiber-optic device includes adjustable mounts accommodated in the inner walls and the light exit ends are accommodated in the adjustable mounts for setting a lighting direction.

In accordance with yet another feature of the invention, the inner walls surrounding the appliance interior space include a baking space divider having an associated fiber-optic element and a connecting element for a light coupling to the optical fibers and/or the light source.

In accordance with a further feature of the invention, the inner walls have a front region, at least some of the light exit ends are integrated in the front region of the inner walls such that light is directed into the appliance interior space.

In accordance with yet another feature of the invention, an appliance door is provided, at least some of the light exit ends are integrated in the appliance door such that light is directed into the appliance interior space.

In accordance with another feature of the invention, the useful region of the appliance interior space defines a plurality of useful levels, a respective number of the light exit ends are configured to evenly illuminate each respective one of the useful levels.

Other features which are considered as characteristic for the invention are set forth in the appended claims.

Although the invention is illustrated and described herein as embodied in a fiber-optic device for the interior lighting of kitchen and household appliances, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of an appliance, open on one side, with a fiber-optic device according to the invention;

FIG. 2 is a diagrammatic perspective view of an adjustable mount for receiving the light exit ends according to the invention; and

FIG. 3 is a diagrammatic perspective view of an appliance having light exit ends in the appliance door according to the invention.

### DESCRIPTION OF THE PREFERRED EMBODIMENTS

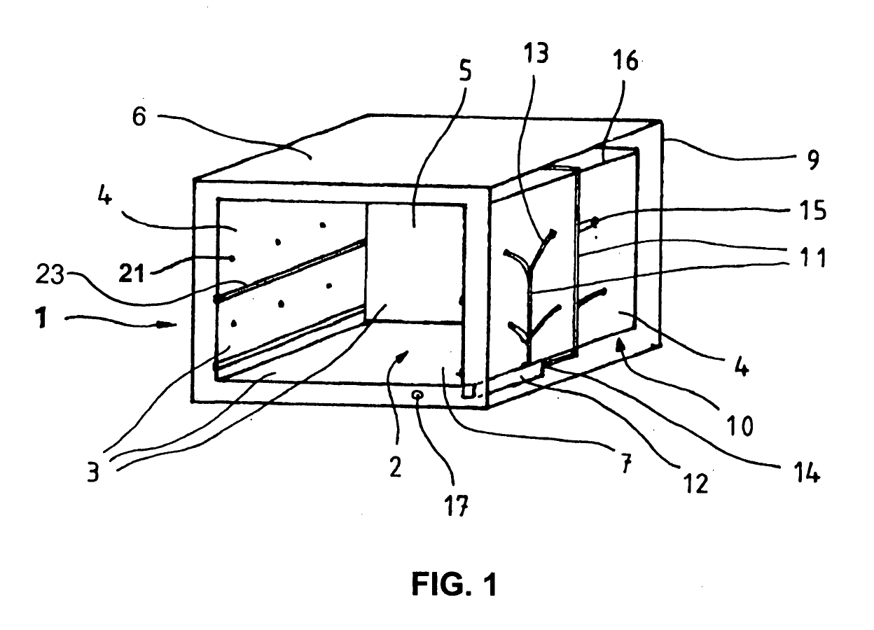

Referring now to the figures of the drawings in detail and first, particularly, to FIG. 1 thereof, there is shown a kitchen or household appliance according to the invention, which for example represents a baking oven 1. The baking oven 1 has an interior space 2, which is bounded by the inner walls 3.

The inner walls 3 include side walls 4 and a rear wall 5, which lies opposite the door opening. In the drawing, the door opening is represented without the baking oven door which closes off the interior space 2 of the baking oven. As upper and lower terminations, the interior space 2 has a top 6 and bottom 7.

The side walls 4 have sliding rails 23, which serve for receiving baking sheets. The inner walls 3 are arranged in a housing 9. Between the inner walls 3 and the housing 9 is the installation space 10. Arranged in the installation space 10 are various items of equipment, electrical or mechanical components and cables for the supply of electrical power or ducts for intake air or expelled vapor.

Arranged in the installation space 10 is the fiber-optic device 11 according to the invention with a light source 12. The light source 12 is arranged in the lower part of the installation space 10 by way of example. However, the invention includes any configuration of the light source 12 in the installation space 10, for example also above the interior space 2 of the baking oven or to the side.

The fiber-optic device 11 has, furthermore, a plurality of fiber bundles 13 with light entry ends 14 and light exit ends 15. The fiber bundles 13 are grouped together at their light entry ends 14 into at least one light entry surface. The light entry surface is in this case assigned to the light source 12 directly or via optical elements, such as for example lenses.

After the light entry surface, the glass fibers are grouped together in strands and led away from the light source 12 in the form of flexible fiber bundles 13. The fiber bundles 13 have a diameter of from 3 to 6 mm, the light-conducting glass fibers or optical fibers having a diameter of between 50 and 100 μm. Covered by the invention in the same way are fiber bundles of heat-resistant light-conducting fibers of plastic or synthetic material.

It is of advantage in this respect that the fiber bundles 13 can consequently be readily bent and bending radii which are less than or equal to 10 mm are realized. As a result, it is possible to lay the fiber bundles 13 flexibly in the installation space 10, even at locations where there is little space, for example past items of equipment or over edges 16 which are formed by two butting inner walls 3.

The light exit ends 15 form the ends of the fiber bundles 13 that are opposite from the light entry ends 14. The light exit ends 15 are assigned to the inner walls 3, each light exit end 15 being led through the associated inner wall 3 or integrated in it, or fastened on the inner wall 3 by fastening devices. In this respect, the light exit ends 15 are directed into the interior space 2 of the baking oven, so that the latter is illuminated in a partial space by the light which is emitted at the corresponding light exit end 15. In this way, even illumination of the interior space 2 of the baking oven is advantageously possible with punctiform lighting locations or point light sources 21 distributed on the inner walls 3, the lighting locations 21 being formed by the light exit ends 15.

The fiber bundles 13 or the individual fibers are accommodated in a protective cladding of temperature-resistant, preferably bendable, and chemically resistant material. According to the invention, it is likewise provided that the protective cladding is formed of temperature-resistant material, in order that high temperatures possibly occurring in the installation space 10 cannot damage the fiber bundles 13. The protective cladding is preferably produced from extrudable plastic or from braided fabrics of temperature-resistant or chemically resistant plastic, glass or metal.

The light exit ends of the fiber bundles are directly accommodated in the inner walls. For this purpose, to increase the temperature resistance, the light exit ends 15 of the glass fibers are adhesively bonded to one another in a temperature-resistant manner or are accommodated in temperature-resistant sleeves. Furthermore, the light exit ends 15 of the individual fibers may be fused by hot melting to increase the temperature resistance of the fiber bundles 13.

According to the invention, it is also provided that the glass fibers are accommodated in adjustable mounts for the setting of the lighting direction, the mounts being produced from heat-resistant material. The mounts make it possible for the lighting direction to be individually set and adapted to the constructional conditions. The user of the baking oven can also set the lighting direction according to his or her wishes.

It has proven to be particularly advantageous for the light exit ends 15 to be integrated in the inner walls 3 or the door of the appliance in the front area of the baking oven 1. In this case, the light exit ends 15 are directed in such a way that the emitted light is directed into the interior space 2 of the baking oven. For leading the fiber bundles through into the baking oven door, an opening 17 is provided in the housing 9 in the front area.

In order that the baking levels, which are determined by the various sliding rails 23 for the baking sheets, are optimally illuminated, a number of light exit ends 15 are arranged uniformly next to one another in the side walls 4 of the baking oven 1.

The light source 12 may be formed according to the invention by a halogen reflector lamp or an LED light source. In the case of an LED light source, it has also proven to be advantageous that each fiber bundle is lit with at least one LED at the light entry end 14. Consequently, great lighting powers can be achieved at the light exit ends 15.

As is indicated in FIG. 1, the light source 12 is accessible by way of example in the front area of the housing 9, preferably through a closable opening 17. This advantageously allows servicing work to be performed on the light source 12 on the installed appliance.

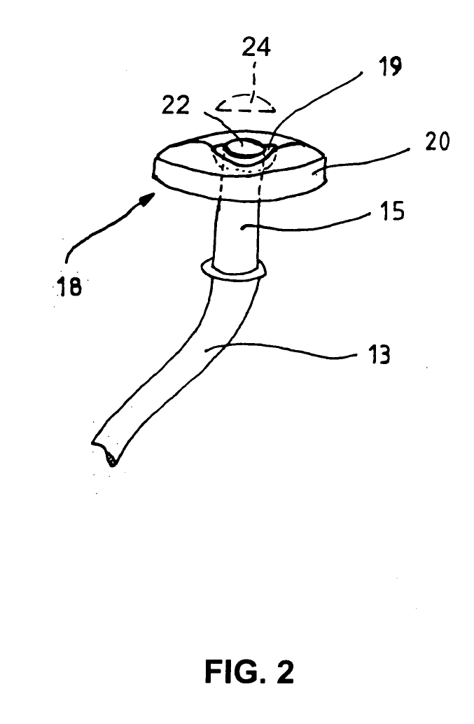

In FIG. 2, an adjustable mount 18 is represented by way of example, as representive also of other methods for the integration, leading-through or fastening of the light exit ends 15. The light exit ends 15 are in this case fixedly accommodated in a movable part 19 of the mount 18. The movable part 19 of the mount 18 can be turned by a certain amount in the fastening part 20 provided for the fastening on the inner walls 3, so that the lighting direction of the light exit ends 15 can be adjusted by a corresponding angle. The movable part 19 of the mount 18 may preferably be equipped with additional optical elements, so that the light can additionally be modulated with the optical elements. An optical element 24 in the shape of a lens is schematically indicated by dashed lines.

The glass fibers are grouped together in a fiber bundle 13, which is accommodated in a protective cladding 22, which is formed of temperature-resistant, preferably bendable, or chemically resistant material and/or braided fabrics of temperature-resistant material.

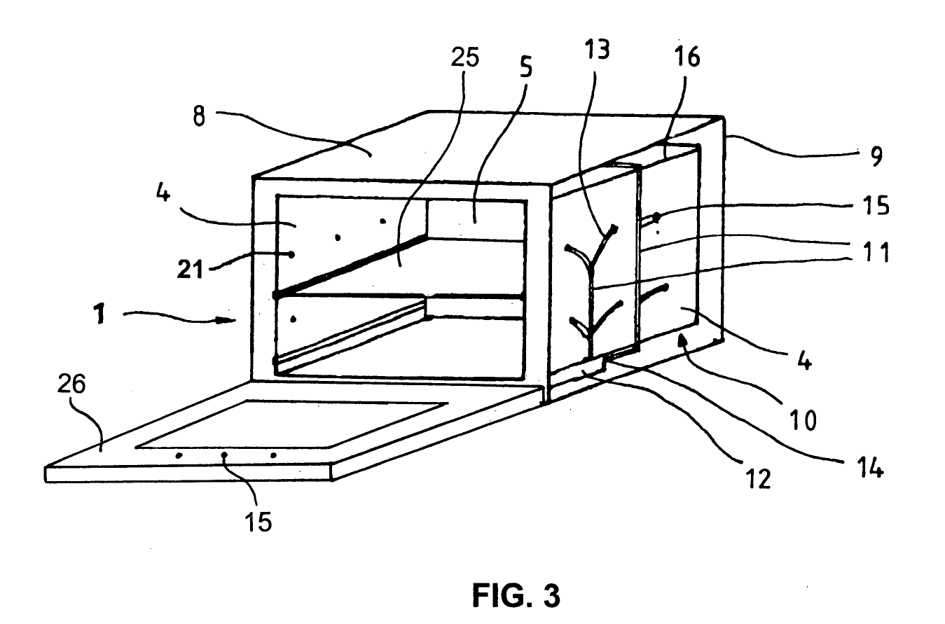

FIG. 3 is a diagrammatic perspective view of a baking oven having a baking space divider 25 and a door 26 with light exit ends 15 integrated in the door 25. This application claims the priority, under 35 U.S.C. § 119, of German patent application No. 10 2004 025 326.9, filed May 19, 2004; the entire disclosure of the prior application is herewith incorporated by reference.

1. In combination with an appliance having inner walls surrounding an appliance interior space defining a useful region with a useful level, a fiber-optic device for lighting the appliance interior space, comprising:
optical fibers having respective light entry ends and light exit ends;
a light source disposed away from the useful region of the appliance interior space, said light entry ends being assigned to said light source;
said optical fibers being grouped into fiber bundles;
said fiber bundles being flexible and extending, with given bending radii, from said light source to the inner walls of the appliance; and
said fiber bundles forming, with said light exit ends, point light sources distributed on the inner walls of the appliance for an even illumination of the appliance interior space.

2. The fiber-optic device according to claim 1, wherein said optical fibers have respective diameters of between 50 and 100 μm.

3. The fiber-optic device according to claim 1, wherein said fiber bundles have at least some bending radii of up to 10 mm.

4. The fiber-optic device according to claim 1, wherein said optical fibers have at least some bending radii of up to 10 mm.

5. The fiber-optic device according to claim 1, including a protective cladding accommodating at least one of said fiber bundles and said optical fibers.

6. The fiber-optic device according to claim 5, wherein said protective cladding is a cladding selected from the group consisting of a temperature-resistant cladding, a bendable cladding, a chemically resistant cladding, and an extruded plastic cladding.

7. The fiber-optic device according to claim 5, wherein said protective cladding is a braided fabric cladding formed of a material selected from the group consisting of plastic, glass, and metal.

8. The fiber-optic device according to claim 1, wherein said optical fibers are formed of a material selected from the group consisting of glass and a heat-resistant light-conducting plastic.

9. The fiber-optic device according to claim 1, wherein said optical fibers are grouped together, at said light entry ends, into a common fiber bundle.

10. The fiber-optic device according to claim 1, wherein:
said optical fibers are grouped together, at said light entry ends, into a common fiber bundle; and
said light entry ends form a light accepting surface for coupling in light emitted by said light source.

11. The fiber-optic device according to claim 1, wherein said optical fibers are grouped together, at said light exit ends, into fiber bundles having a diameter of between 3 and 6 mm.

12. The fiber-optic device according to claim 1, wherein said light exit ends are adhesively bonded to one another in a temperature-resistant manner for increasing temperature resistance of said fiber bundles.

13. The fiber-optic device according to claim 1, including temperature resistant sleeves, said light exit ends being accommodated in said temperature resistant sleeves for increasing temperature resistance of said fiber bundles.

14. The fiber-optic device according to claim 1, wherein said light exit ends of said optical fibers are fused by hot melting for increasing temperature resistance of said fiber bundles.

15. The fiber-optic device according to claim 1, including optical elements configured to modulate light emitted from said light exit ends into the appliance interior space, said optical elements being one of integral elements and additional elements.

16. The fiber-optic device according to claim 15, wherein said optical elements for modulating light are formed of temperature resistant glass.

17. The fiber-optic device according to claim 1, wherein said light source includes at least one light source selected from the group consisting of a halogen reflector lamp and a light emitting diode.

18. The fiber-optic device according to claim 1, wherein said light source includes at least one light emitting diode for each of said fiber bundles.

19. An appliance, comprising:
inner walls surrounding an appliance interior space defining a useful region with a useful level;
a fiber-optic device for lighting the appliance interior space;
said fiber-optic device including optical fibers with respective light entry ends and light exit ends, a light source disposed away from the useful region of the appliance interior space, said light entry ends being assigned to said light source;
said optical fibers being grouped into fiber bundles;
said fiber bundles being flexible and extending, with given bending radii, from said light source to said inner walls; and
said fiber bundles forming, with said light exit ends, point light sources distributed on said inner walls for an even illumination of the appliance interior space.

20. The appliance according to claim 19, wherein said inner walls are one of baking appliance walls and refrigerating appliance walls for industrial use.

21. The appliance according to claim 19, wherein said fiber-optic device is configured as an interior lighting for one of a kitchen appliance and a household appliance.

22. The appliance according to claim 19, wherein said light exit ends are integrated in said inner walls.

23. The appliance according to claim 19, wherein said light exit ends extend through said inner walls.

24. The appliance according to claim 19, wherein said light exit ends are accommodated directly in said inner walls for setting a lighting direction.

25. The appliance according to claim 19, wherein said fiber-optic device includes adjustable mounts accommodated in said inner walls, said light exit ends are accommodated in said adjustable mounts for setting a lighting direction.

26. The appliance according to claim 19, wherein said inner walls surrounding the appliance interior space include a baking space divider having an associated fiber-optic element and a connecting element for a light coupling to one of said optical fibers and said light source.

27. The appliance according to claim 19, wherein said inner walls have a front region, at least some of said light exit ends are integrated in said front region of said inner walls such that light is directed into the appliance interior space.

28. The appliance according to claim 19, including an appliance door, at least some of said light exit ends being integrated in said appliance door such that light is directed into the appliance interior space.

29. The appliance according to claim 19, wherein the useful region of the appliance interior space defines a plurality of useful levels, a respective number of said light exit ends are configured to evenly illuminate each respective one of the useful levels.
